(19) United States
(12) Patent Application Publication
(10) Pub. No.: US 2006/0056871 A1
(43) Pub. Date: Mar. 16, 2006

(54) Image forming apparatus and method of controlling the image forming apparatus

(76) Inventor: Haeng-nan Kim, Suwon-si (KR)

Correspondence Address: STANZIONE & KIM, LLP, 919 18TH STREET, N.W., SUITE 440, WASHINGTON, DC, 20006, US

(21) Appl. No.: 11/218,550

(22) Filed: Sep. 6, 2005

(30) Foreign Application Priority Data
Sep. 10, 2004 (KR) 2004-72681

(51) Int. Cl. G03G 15/00

(52) U.S. Cl. 399/81

(57) ABSTRACT

An image forming apparatus and a method of controlling the same. The method includes creating menu screens corresponding to one or more the image formation-related functions using a web browser provided to the image forming apparatus, and displaying each of the created menu screens by the web browser. Accordingly, it is possible to provide a menu screen only with a simple and fast producing process.

### CROSS-REFERENCE TO RELATED APPLICATIONS

This application claims benefit under 35 U.S.C. § 119 from Korean Patent Application No. 2004-72681, filed on Sep. 10, 2004 in the Korean Intellectual Property Office, the content of which is incorporated herein in its entirety by reference.

### BACKGROUND OF THE INVENTION

1. Field of the Invention

The present general inventive concept relates to an image forming apparatus and a method of controlling the image forming apparatus. More particularly, the present general inventive concept relates to an image forming apparatus to create a menu screen regarding an image formation-related function and a method of controlling the same.

2. Description of the Related Art

An image forming apparatus prints an image corresponding to original image data input to the forming apparatus on a recording medium, such as a printing sheet. The image forming apparatus includes, for example, a printer, a duplicating machine, a facsimile machine, and the like. Recently, the image forming apparatus has been provided with a combined device of a displaying section and a user inputting section, such as a touch screen panel, so that a user's command is input or a notifying message is displayed to a user. In addition, a menu screen for setting up diverse image formation-related functions of the image forming apparatus is displayed on the touch screen panel.

According to the prior art, the menu screen is created into a graphic image and then displayed on the touch screen panel. The menu screens regarding the image formation-related functions are provided with setting buttons to allow a user to adjust settings of corresponding functions. When a setting button provided on the menu screen is selected, a position coordinate of the selected setting button is transmitted to a controlling section, so that the controlling section recognizes the selection of the corresponding function of the selected setting button. According to the selection of the selected setting button, another menu screen is displayed or the corresponding function is executed in the image forming apparatus.

However, a complicated and cumbersome producing process is required to display the menu screen on the touch screen panel. For example, menu structures considering all of the image formation-related functions of the image forming apparatus and all possible scenarios of the menu screens must be prepared. Menu screens regarding each of the image formation-related functions must be designed according to the prepared scenarios. In other words, graphic images of all the menu screens, which are one-to-one mapped considering all of the possible scenarios of the menu screens and a size of the displaying section, must be developed. Accordingly, hundreds of graphic images of the menu screens must typically be prepared. The number of the graphic images needed increases when the image formation-related functions adopted to the image forming apparatus are more diverse. The conventional menu screens require a long time to provide and much labor is required for the producing process, so that producing costs are excessive.

In addition, there is another problem that a menu screen of any one image forming apparatus cannot be applied to another image forming apparatus when the displaying sections or image formation-related functions adopted are different. Accordingly, even when the menu screens are prepared with much time and effort, the prepared menu screens can be applied to only one product.

### SUMMARY OF THE INVENTION

Accordingly, the present general inventive concept provides an image forming apparatus capable of creating and displaying a menu screen in a web browsing operation and a method of controlling the same.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a method of controlling an image forming apparatus adopting one or more image formation-related functions, the method comprising creating menu screens corresponding to the one or more image formation-related functions using a web browser provided to the image forming apparatus, and displaying each of the created menu screens by the web browser.

The creating of the menu screens may include driving the web browser when power is applied to the image forming apparatus, downloading an applet stored in a web server of the image forming apparatus through the web browser, and creating a main menu screen with main menu screen information stored in a memory of the image forming apparatus, by the applet.

The creating of the main menu screen may include requesting the web server for the main menu screen information by the web browser, reading and providing the main menu screen information to the web browser by the web server according to the request for the main menu screen information by the web browser, and creating the main menu screen by the applet based on the provided main menu screen information.

The creating of the menu screens may further include when a submenu screen-displaying command regarding one of the image formation-related functions is input, creating a submenu screen corresponding to the one of the image-formation related functions with submenu screen information regarding the one of the image-formation related functions stored in the memory of the image forming apparatus by the applet.

The creating of the submenu screen corresponding to the one of the image-formation related functions may include requesting the web server for the submenu screen information regarding the one of the image-formation related functions by the web browser, reading and providing the submenu screen information regarding the one of the image-formation related functions to the web browser by the web server according to the request for the submenu screen information regarding the one of the image-formation related functions, and creating the submenu screen corresponding to the one of the image-formation related functions by the applet based on the provided submenu screen information regarding the one of the image-formation related functions.

The main menu screen information and the submenu screen information regarding the one of the image-formation related functions may include a web document, such as an extendible markup language (XML) or hypertext markup language (HTML).

The main menu screen information and the submenu screen information regarding the one of the image-formation related may include information regarding menu screen constituting elements to be displayed on each of the menu screens and information regarding a menu screen structure regarding a position, a size a color, etc., of the menu screen constituting elements that are displayed on each of the menu screens.

The foregoing and/or other aspects of the present general inventive concept may also be achieved by providing an image forming apparatus having one or more image formation-related functions, the image forming apparatus comprising a displaying section, and a menu screen-processing section to create menu screens corresponding to the one or more image formation-related functions using a web browsing operation and to process each of the created menu screens to be displayable on the displaying section.

The menu screen-processing section may create a main menu screen of the menu screens when power is applied to the image forming apparatus, and then process the created main menu screen to display the main menu screen on the displaying section.

The image forming apparatus may further include a user input section to select a display-requested menu screen of the menu screens to be displayed on the displaying section, and the menu screen-processing section may create the display-requested menu screen selected.

The image forming apparatus may further include a memory section to store menu screen information regarding each of the menu screens, and a web server module to read information regarding the display-requested menu screen from the memory section when the information regarding the display-requested menu screen is requested by the menu screen-processing section, and to transmit the read information relating to the display-requested menu screen to the menu screen-processing section. The menu screen-processing section may create the display-requested menu screen according to the transmitted information regarding the display-requested menu screen.

The menu screen information may include at least one of information regarding menu screen constituting elements to be displayed on the menu screens and information of a menu screen structure regarding a position, a size, a color, etc., of the menu screen constituting elements that are displayed on each of the menu screens.

Thus, it is possible to provide a menu screen only by a simple and fast menu screen producing process.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic view illustrating an image forming apparatus according to an embodiment of the present general inventive concept;

FIG. 2 is a flowchart illustrating a method of creating and displaying a menu screen in the image forming apparatus of FIG. 1;

FIG. 3 is a schematic view illustrating an image forming apparatus according to another embodiment of the present general inventive concept; and

FIG. 4 is a flowchart illustrating a method of creating and displaying a menu screen in the image forming apparatus of FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

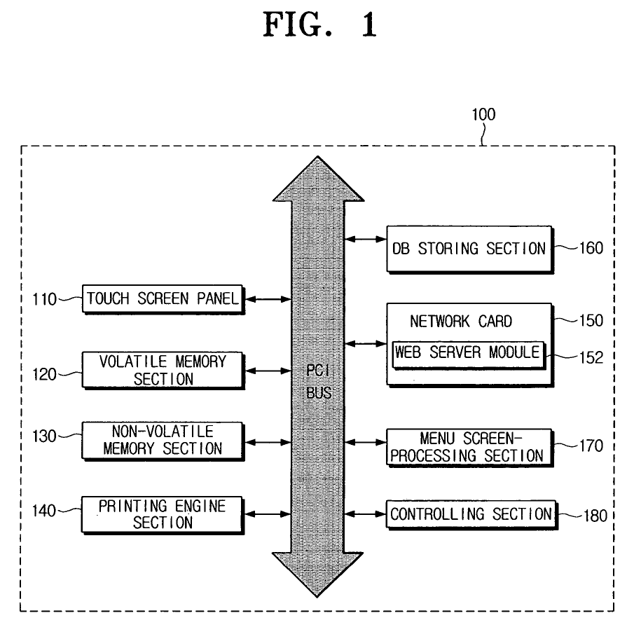

FIG. 1 schematically illustrates an image forming apparatus 100 according to an embodiment of the present general inventive concept.

Referring to FIG. 1, the image forming apparatus 100 includes a touch screen panel 110, a volatile memory section 120, a non-volatile memory section 130, a printing engine section 140, a network card 150, a database (DB) storing section 160 to store a database of constituting elements of a menu screens, a menu screen-processing section 170 and a controlling section 180.

The touch screen panel 110 can act as a displaying section and a user command inputting section, respectively.

As the displaying section, the touch screen panel 110 displays various user notifying messages under control of the controlling section 180. In addition, the touch screen panel 110 displays a main menu screen and submenu screens corresponding to various image formation-related functions of the image forming apparatus 100 under control of the controlling section 180. The main menu screen is initially displayed when power is applied to the image forming apparatus 100, and can be provided with a plurality of selection buttons capable of selecting the various image formation-related functions of the image forming apparatus 100. Each of the submenu screens corresponding to the diverse image formation-related functions can be displayed according to a selection of one of the selection buttons in the main menu screen, and can be provided with a plurality of setting buttons to allow a user to adjust settings of the corresponding image formation-related function.

As the user command input section, the user can input a printing-related command through the touch screen panel 110. Based on the main menu screen, the user can input a selection command of the image formation-related functions, that is, a command to display a selected one of the submenu screens through the touch screen panel 110. In addition, based on the selected submenu screen, various setting commands to adjust the settings of the corresponding image formation-related function can be input through the touch screen panel 110. The selected submenu screen may correspond to a display-requested sub-menu screen.

The volatile memory section 120 is a storing area to temporarily store data occurring during an image forming operation or other controlling operations.

The non-volatile memory section 130 stores a control program which controls the image forming apparatus 100.

The printing engine section 140 prints an image corresponding to printing data on a printing sheet, according to a control of the controlling section 180.

The network card 150 is a network interface card and connects the image forming apparatus 100 to an information processing apparatus, such as a computer.

The network card 150 can include a web server module 152. The web server module 152 can be used to transmit various types of information to the information processing apparatus, such as the computer, connected to the image forming apparatus 100 by the network card 150. In other words, it is possible to remotely control the image forming apparatus 100 by the information processing apparatus through the web server module 152. In addition, when a request signal for menu screen information is transmitted from the menu screen-processing section 170, the web server module 152 reads images and icons, i.e., menu screen constituting elements, required to create the menu screen and stored in the DB storing section 160 from the DB storing selection 160. The menu screen-processing section 170 receives information regarding a structure of the menu screen and the menu screen constituting elements from the web server module 152, based on the request signal in real-time. A whole image constituting the menu screen as displayed on the touch screen panel 110 is not stored in the DB storing section 160 but only the menu screen constituting elements required to create the menu screen are stored therein. Additionally, the menu screen structure information relates to a position, a size, a color, etc., of the menu screen constituting elements as displayed in the corresponding menu screen. The menu screen constituting elements may include, for example, the above-mentioned selection buttons and the setting buttons, etc.

The menu screen-processing section 170 creates the menu screen according to a user command input in the touch screen panel 110. A method of creating the menu screen according to the embodiment of the present i general inventive concept, adopts a web browsing operation wherein a web-based programming language, to create a web page on a client computer connected to the Internet is used. Accordingly, the menu screen-processing section 170 receives the menu screen information from the web server module 152 of the network card 150, and creates the menu screen using the menu screen information received. The menu careen information includes the information relating to the structure of the menu screen structure and the menu screen-constituting elements.

When a power apply-notifying signal is transmitted from the controlling section 180, the menu screen-processing section 170 transmits a signal requesting the main menu screen information to the web server module 152. When the main menu screen information is thus transmitted, the menu screen-processing section 170 creates the main menu screen using the main menu screen information. The menu screen-processing section 170 processes the created main menu screen to display the main menu screen on the touch screen panel 110.

When a submenu screen-displaying command regarding one of the image formation-related functions is input through the touch screen panel 110, a displaying request-notifying signal is transmitted from the controlling section 180, and the menu screen-processing section 170 transmits a signal requesting the submenu screen information to the web server module 152 according to the displaying-request notifying signal transmitted from the controlling section 180. When the submenu screen information is transmitted accordingly, the menu screen-processing section 170 creates a corresponding submenu screen using the submenu screen information. The menu screen-processing section 170 processes the created submenu screen to display the created submenu screen on the touch screen panel 110.

The controlling section 180 is connected to each of the blocks in the image forming apparatus 100 by a local bus. A peripheral component interconnect (PCI) or industry standard architecture (ISA) can be employed as the local bus. The controlling section 180 controls an overall operation of the image forming apparatus 100 according to a control program stored in the non-volatile memory section 130 of the image forming apparatus 100.

When a power is applied to the image forming apparatus 100, the controlling section 180 transmits the power apply-notifying signal to the menu screen-processing section 170. When the submenu screen-displaying command regarding one of the image formation-related functions is input through the touch screen panel 110, the controlling section 180 transmits the displaying request-notifying signal to the menu screen-processing section 170.

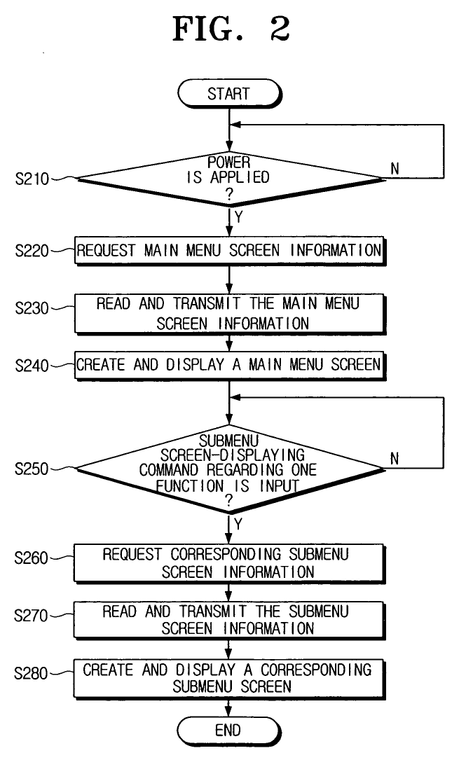

FIG. 2 is a flowchart illustrating a method of creating and displaying a menu screen using a web browsing operation in the image forming apparatus of FIG. 1.

Referring to FIGS. 1 and 2, when the power is applied to the image forming apparatus 100 and thus the power apply-notifying signal is transmitted from the controlling section 180 (S210), the menu screen-processing section 170 transmits the signal requesting the main menu screen information to the web server module 152 (S220). Next, the web server module 152 retrieves and reads the main menu screen information stored in the DB storing section 160, and transmits the main menu screen information to the menu screen-processing section 170 (S230). The menu screen-processing section 170 creates the main menu screen based on the transmitted main menu screen information, and processes the created main menu screen to display the main menu screen on the touch screen panel 110 (S240).

When a user inputs the submenu screen-displaying command corresponding to one of the image formation-related functions, selected in the main menu screen displayed on the touch screen panel 110, the displaying request-notifying signal is transmitted from the controlling section 180 (S250), and the menu screen-processing section 170 transmits a signal requesting the corresponding submenu screen information to the web server module 152 according to the displaying request-notifying signal (S260). The web server module 152 retrieves and reads the corresponding submenu screen information stored in the DB storing section 160, and transmits the corresponding submenu screen information to the menu screen-processing section 170 (S270). The menu screen-processing section 170 creates the corresponding submenu screen, based on the transmitted corresponding submenu screen information, and processes the created submenu screen to display the created submenu screen on the touch screen panel 110 (S280).

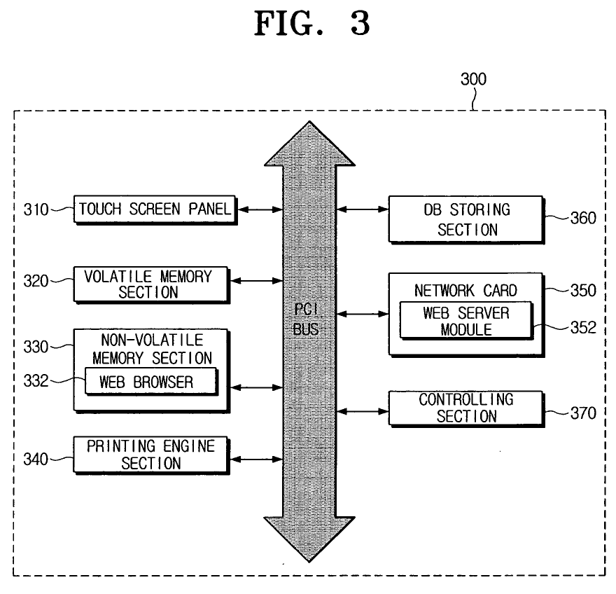

FIG. 3 is a schematic view illustrating an image forming apparatus 300 according to another embodiment of the present general inventive concept. Since a touch screen panel 310, a volatile memory section 320, a printing engine section 340, a network card 350 having a web server module 352, and a DB storing section 360 to store a database of constituting elements of a menu screen of the image forming apparatus 300 of FIG. 3 are substantially the same as the touch screen panel 110, the volatile memory section 120, the printing engine section 140, the network card 150 having the web server module 152, and the DB storing section 160 of the image forming apparatus 100 of FIG. 1, detailed descriptions thereof are omitted for brevity.

In the image forming apparatus 300 of FIG. 3, a web browser 322 stored in a non-volatile memory section 330 is driven under control of a controlling section 370 to create a menu screen, as opposed of the menu screen-processing section 170 of the image forming apparatus of FIG. 1. The web browser 332 may be, for example, an Internet explorer or a Netscape navigator.

When power is applied to the image forming apparatus 300, an applet, which is downloaded from a web server module 352 by a request of the web browser 332, creates the menu screen based on menu screen information transmitted from the web server module 352. The web browser 332 and the web server module 352 communicate with each other using a transmitting protocol, such as a hypertext transfer protocol (HTTP). In addition, the menu screen information can include a hypertext markup language (HTML). The applet can be an application program being executed through the web browser 332 and represents a menu screen creation-related applet in this embodiment.

The created menu screen is displayed on the touch screen panel 310 by the web browser 332.

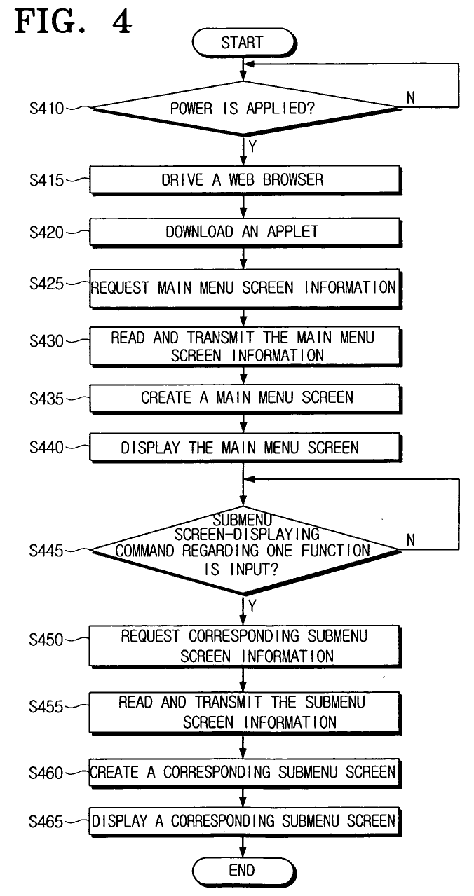

FIG. 4 is a flowchart illustrating a method of creating and displaying a menu screen using a web browsing operation in the image forming apparatus of FIG. 3.

Referring to FIGS. 3 and 4, when the power is applied to the image forming apparatus 300 (S410), the controlling section 370 drives the web browser 332 stored in the non-volatile memory section 330 (S415). The web browser 332 downloads the menu screen creation-related applet from the web server module 332 (S420). The web browser 332 then transmits a signal requesting main menu screen information to the web server module 352 (S425). The web server module 352 retrieves and reads the main menu screen information from the DB storing section 360, and transmits the main menu screen information to the web browser 332 (S430). Next, the applet creates a main menu screen based on the transmitted main menu screen information (S435). The created main menu screen is processed to be displayed on the touch screen panel 310 by the web browser 332 (S440).

When a user inputs a submenu screen-displaying command regarding one of the image formation-related functions of the image forming apparatus 300, in the main menu screen displayed on the touch screen panel 310 (S445), the web browser 332 transmits a signal requesting the corresponding submenu screen information to the web server module 352 (S450). The web server module 352 retrieves and reads the corresponding submenu screen information stored in the DB storing section 360, and transmits the corresponding submenu screen information to the web browser 332 (S455). The applet creates a corresponding submenu screen based on the transmitted corresponding submenu screen information (S460). The created submenu screen is processed to be displayed on the touch screen panel 310 by the web browser 332 (S465).

Although the touch screen panels 110 and 310 are illustrated in the above embodiments, it may be considered to separately provide a displaying section and a user command-inputting section instead of the touch screen panels 110 and 310, and it is obvious that such embodiments are within the scope of the present general inventive concept.

Although the DB storing sections 160 and 360 are illustrated in the above embodiments, it may be considered to store the menu screen information in a storing area of the non-volatile memory sections 130 and 330, instead of separately providing the DB storing sections 160 and 360 to store a database of the constituting elements of the menu screens, and it is obvious that such embodiments are also within a scope of the present general inventive concept.

The various embodiments of the present general inventive concept may be embodied as executable code in computer readable media including storage media, such as magnetic storage media (ROMs, RAMs, floppy disks, magnetic tapes, etc.), optically readable media (CD-ROMs, DVDs, etc.), and carrier waves (transmission over the Internet).

As described above, according to various embodiments of the present general inventive concept, it is possible to provide a menu screen using a simple and fast menu screen producing process. A web browsing method is used to create a menu screen, so that the menu screen can be created by a simple method and it is possible to easily perform an update and a change of the menu screen resulting from an addition, deletion, or change of an image formation-related function. Accordingly, it is possible to reduce costs to produce, process, and maintain the menu screen. Additionally, since the menu screen can be easily changed, a change of language according to countries can be performed with a simple operation.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling an image forming apparatus having one or more image formation-related functions, the method comprising:
creating menu screens corresponding to one or more image formation-related functions using a web browser provided to the image forming apparatus; and
displaying each of the created menu screens by the web browser.

2. The method as claimed in claim 1, wherein the creating of the menu screens comprises:
driving the web browser when power is applied to the image forming apparatus;
downloading an applet from a web server of the image forming apparatus through the web browser; and
creating a main menu screen with main menu screen information stored in a memory of the image forming apparatus by the applet.

3. The method as claimed in claim 2, wherein the creating of the main menu screen comprises:
requesting the web server for the main menu screen information by the web browser;
reading and providing the main menu screen information to the web browser by the web server according to the request for the main menu screen information by the web browser; and
creating the main menu screen by the applet, based on the provided main menu screen information provided.

4. The method as claimed in claim 2, wherein the creating of the menu screens further comprises:
creating a submenu screen corresponding to one of the image formation-related functions with sub main menu screen information regarding the one of the image formation-related functions stored in the memory of the image forming apparatus by the applet when a submenu screen-displaying command corresponding to the one of the image formation-related functions is input.

5. The method as claimed in claim 4, wherein the creating of the submenu screen corresponding to the one of the image formation-related functions comprises:
requesting the web server for the sub main menu screen information regarding the one of the image formation related functions by the web browser;
reading and providing the submenu screen information regarding the one of the image formation related functions to the web browser by the web server, according to the request for the submenu screen information regarding the one of the image formation related functions; and
creating the submenu screen corresponding to the one of the image formation related functions by the applet, based on the submenu screen information regarding the one of the image formation related functions provided.

6. The method as claimed in claim 4, wherein the main menu screen information and the submenu screen information regarding the one of the image formation related functions comprise at least one web document of an extendible markup language (XML) and a web document hypertext markup language (HTML).

7. The method as claimed in claim 4, wherein the main menu screen information and the submenu screen information regarding the one of the image formation related functions comprises at least one of information regarding menu screen constituting elements to be displayed on each of the main and sub menu screens and information regarding a menu screen structure including a position, a size, and a color of the menu screen constituting elements which are displayed on each of the menu screens.

8. A method of controlling an image forming apparatus, comprising:
requesting a menu screen to be displayed on a display of the image forming apparatus;
automatically creating the requested menu screen using a web based language; and
displaying the created menu screen on the display of the image forming apparatus.

9. The method as claimed in claim 8, wherein the requesting of the menu screen comprises:
automatically requesting a main menu screen when power is supplied to the image forming apparatus.

10. The method as claimed in claim 9, wherein the automatically creating of the requested menu screen comprises:
loading predetermined main menu information stored in a memory of the image forming apparatus; and
creating the main menu screen having one or more selectable submenus according to the predetermined main menu information using the web based language.

11. The method as claimed in claim 8, wherein the requesting of the menu screen comprises:
selecting a submenu from a main menu screen displayed on the display of the image forming apparatus; and
requesting a submenu screen corresponding to the selected submenu.

12. The method as claimed in claim 11, the automatically creating of the requested menu screen comprises:
loading information regarding the selected submenu stored in a memory of the image forming apparatus; and
creating the requested submenu screen according to the loaded information regarding the selected submenu using the web based language.

13. The method as claimed in claim 12, wherein the displaying of the created menu screen comprises:
replacing the main menu screen displayed on the display of the image forming apparatus with the created submenu screen.

14. The method as claimed in claim 8, wherein the automatically creating of the requested menu screen comprises:
downloading a predetermined applet from an Internet source using a web browser; and
creating the requested menu screen in the downloaded applet using the web based language.

15. The method as claimed in claim 8, wherein the web based language comprises one of extendible markup language (XML) and hypertext markup language (HTML).

16. A method of controlling an image forming apparatus, comprising:
creating a main menu web page having one or more selectable submenus when power is supplied to the image forming apparatus;
displaying the main menu web page on a display of the image forming apparatus;
sensing a selection of one of the one or more submenus of the displayed main menu web page;
creating a submenu web page having one or more selectable settings of the image forming apparatus corresponding to the selected one of the one or more submenus when the selection of the one of the one or more submenus is sensed; and
displaying the created submenu web page on the display of the image forming apparatus.

17. An image forming apparatus having one or more image formation-related functions, comprising:
a displaying section; and
a menu screen-processing section to create menu screens corresponding to the one or more the image formation-related functions by using a web browsing operation to process and the created menu screens to be displayable on the displaying section.

18. The apparatus as claimed in claim 17, wherein the menu screen-processing section creates a main menu screen of the menu screens when a power is applied to the image forming apparatus, and then processes the created main menu screen to display the main menu screen on the displaying section.

19. The apparatus as claimed in claim 17, further comprising:
a user input section to select a display-requested menu screen of the menu screens to be displayed on the displaying section,
wherein the menu screen-processing section creates the selected display-requested menu screen selected.

20. The apparatus as claimed in claim 19, further comprising:
a memory section to store menu screen information regarding each of the menu screens; and
a web server module to read information regarding the display-requested menu screen from the memory section when the information regarding the display-requested menu screen is requested from the menu screen-processing section, and to transmit the display-requested menu screen information read to the menu screen-processing section,
wherein the menu screen-processing section creates the display-requested menu screen according to the information about the display-requested menu screen transmitted.

21. The apparatus as claimed in claim 20, wherein the menu screen information comprises at least one of information regarding menu screen constituting elements to be displayed on the menu screens and information regarding a menu screen structure regarding a position, a size, and a color of the menu screen constituting elements which are displayed on each of the menu screens.

22. A computer readable storage medium having executable codes to perform a method of controlling an image forming apparatus having one or more image formation-related functions, the method comprising:
creating menu screens corresponding to one or more image formation-related functions using a web browser provided to the image forming apparatus; and
displaying each of the created menu screens by the web browser.

23. A computer readable storage medium having executable codes to perform a method of controlling an image forming apparatus, the method comprising:
requesting a menu screen to be displayed on a display of the image forming apparatus;
automatically creating the requested menu screen using a web based language; and
displaying the created menu screen on the display of the image forming apparatus.
